(19) United States
(12) Patent Application Publication
(10) Pub. No.: US 2024/0302300 A1
(43) Pub. Date: Sep. 12, 2024

(54) Material Detection in X-Ray Security Screening

(71) Applicant: Rapiscan Holdings, Inc., Hawthorne, CA (US)

(72) Inventor: Simon Archambault, St-Laurent (CA)

(21) Appl. No.: 18/667,352

(22) Filed: May 17, 2024

Related U.S. Application Data
(63) Continuation of application No. 17/378,037, filed on Jul. 16, 2021, now Pat. No. 12,019,035.

(51) Int. Cl. G01N 23/18; G01N 23/04; G01N 23/083; G01N 23/10; G06T 5/00

(52) U.S. Cl. CPC G01N 23/18; G01N 23/04; G01N 23/083; G01N 23/10; G06T 5/00; G01N 2223/04; G01N 2223/3308; G01N 2223/401; G01N 2223/643; G01N 2223/652; G06T 2207/10116

(57) ABSTRACT

A method for detecting the maximum potential presence of a material in an object. The method includes obtaining raw x-ray image data comprising a plurality of pixels for the object from an X-ray scanning device, wherein each pixel of the plurality of pixels has associated therewith an attenuation value and an effective atomic number (Z_{eff}) for the pixel. The method further includes converting, for each pixel having a Z_{eff} value greater than a threshold effective atomic number (Z_{eff-threshold}), the Z_{eff} at the pixel to the Z_{eff-threshold} while applying a correction factor to the attenuation value for the pixel to bring the attenuation value into correspondence with the conversion of the Z_{eff} value for the pixel and determining a maximum potential amount of the material present at each pixel based on the corrected attenuation value at the pixel. This renders material more apparent in visual display.

### CROSS-REFERENCE

The present application is a continuation application of U.S. patent application Ser. No. 17/378,037, titled “Material Detection in X-Ray Security Screening” and filed on Jul. 16, 2021, which is herein incorporated by reference in its entirety.

### TECHNICAL FIELD

The present disclosure generally relates to a system and method for material detection in x-ray security screening. More particularly, the present disclosure relates to a system and method for detecting the presence of organic materials, such as explosives, in x-ray security screening.

### BACKGROUND

X-ray inspection systems are used for detecting threats (e.g., explosives, drugs or other potentially dangerous materials) in cargo, baggage and parcels in airports, ports and other check-points. The images produced by the X-ray machines are used to detect potential threats either visually by operator analysis, or automatically using software algorithms. However, cargo and baggage are often cluttered and layered with various objects. In the resultant X-ray images, it may be difficult for a human operator reviewing the information produced by an x-ray scanning operation to distinguish an organic material from other overlaying or underlaying inorganic materials like metals. Many objects and materials of interest are organic in nature. Some examples may include explosive materials. In other instances, the material of interest in x-ray screening images may be metals, such as Aluminum. Therefore, providing information to human operators which makes the presence of a material of interest more apparent in cluttered bags is still a challenge.

X-ray systems with image processing functionalities like inorganic stripping (organic only) mode and effective atomic number-based coloration have been developed to help address this problem. However, these methods only show the organic material that is present and reliably detected and accordingly is not necessarily very apparent to a human operator reviewing the information. For example, a very thin layer of organic material may be very difficult to distinguish without further processing to enhance coloration. Explosive detection algorithms have also been created to enhance automated detection of explosives and other threats. Other solutions include using computed tomography (CT) scanners for detection of explosives. However, these tend to be more expensive as compared to X-ray scanners.

It is therefore desired to have an X-ray screening system that allows an operator to visually see if an image region contains a material of interest and therefore a potential threat.

### SUMMARY

The present disclosure generally relates to a system and method for material detection in x-ray security screening. More particularly, the present disclosure relates to a system and method for detecting the presence of organic materials, such as explosives, in an x-ray security screening.

In one aspect, there is provided a method for detecting the presence of a material in an object. The method includes obtaining raw x-ray image data for the object from an X-ray scanning device, the raw x-ray image data comprising a plurality of pixels, wherein each pixel of the plurality of pixels has associated therewith an attenuation value and an effective atomic number (Z_{eff}) value, and converting, for each pixel having a Z_{eff} value greater than a threshold effective atomic number (Z_{eff-threshold}), the Z_{eff} at the pixel to the Z_{eff-threshold} while applying a correction factor to the attenuation value for the pixel to bring the attenuation value into correspondence with the conversion of the Z_{eff} value for the pixel. The method further includes determining a maximum potential amount of material present at each pixel based on the corrected attenuation value at the pixel.

The method may further include the step of generating an image showing the maximum potential amount of the material that is present at each pixel of the image. In a further aspect, the image may be visually displayed to a human operator. This information makes the presence of the material more apparent and therefore makes it easier to identify potential threats.

In one aspect, the method includes the step of determining the Z_{eff-threshold} value based on an effective atomic number of a calibration material. In a further aspect, the material to be detected is an organic material and the calibration material is plexiglass. In another aspect, the material to be detected is an inorganic material like aluminum and the calibration material is aluminum.

In one aspect, when the Z_{eff} value of a pixel is converted to the Z_{eff-threshold}, the correction factor applied to the attenuation value of the pixel is based on a difference between the Z_{eff} at the pixel and the Z_{eff-threshold}. The correction factor can be obtained from a look-up table storing attenuation values and Z_{eff} values for various material overlaps. The corrected attenuation value of a pixel is used to identify the maximum amount of the material that maybe present at the pixel.

In another aspect, there is provided a system for detecting the presence of a material in an object. The system includes an x-ray scanning device for obtaining raw x-ray image data, the raw x-ray image data comprising a plurality of pixels, wherein each pixel of the plurality of pixels has associated therewith an attenuation value and an effective atomic number (Z_{eff}) for the pixel. The system further includes at least one processor configured to convert, for each pixel having a Z_{eff} value greater than a threshold effective atomic number (Z_{eff-threshold}), the Z_{eff} at the pixel to the Z_{eff-threshold} while applying a correction factor to the attenuation value for the pixel to bring the attenuation value into correspondence with the conversion of the Z_{eff} value for the pixel, and determine a maximum potential amount of the material that is present at each pixel based on the corrected attenuation value at the pixel.

The processor may be further configured to generate an image showing the maximum amount of the material that is present at each pixel of the image. In a further aspect, the processor is further configured to provide the image to a display. This visual display of the image makes the presence of the material more apparent and therefore makes it easier to identify potential threats.

In another aspect, there is provided a method for enhancing a display of raw x-ray image data of an object to identify if a region of the object contains organic material. The method includes obtaining the raw x-ray image data of the object, wherein the raw image data comprises a plurality of pixels, and wherein each pixel of the plurality of pixels has associated therewith an attenuation value and an effective atomic number (Z_{eff}), converting, for each pixel having a Z_{eff} value greater than a threshold effective atomic number for the organic material (Z_{eff-threshold}), the Z_{eff} at the pixel to the Z_{eff-threshold} while applying a correction factor to the attenuation value for the pixel to bring the attenuation value into correspondence with the conversion of the Z_{eff} value for the pixel, and displaying an image of the object showing a maximum potential amount of the organic material present at each pixel based on the corrected attenuation value of the pixel.

### BRIEF DESCRIPTION OF THE DRAWINGS

Exemplary non-limiting embodiments are described with reference to the accompanying drawings in which:

FIG. 1 is an illustration of an exemplary x-ray scanning device which may be used in accordance with the invention;

FIG. 2 is a diagram representation of a system which may be used in one aspect of the invention;

FIG. 3 is a flow chart illustrating a material detection process according to one aspect of the invention;

FIG. 4A is top view of an original x-ray image generated in accordance with one aspect of the invention; and,

FIG. 4B is top view of a modified x-ray image generated in accordance with one aspect of the invention.

### DETAILED DESCRIPTION

The present disclosure generally relates to a system and method for material detection in x-ray security screening. More particularly, the present disclosure relates to a system and method for detecting the presence of organic materials, such as explosives, in an x-ray security screening.

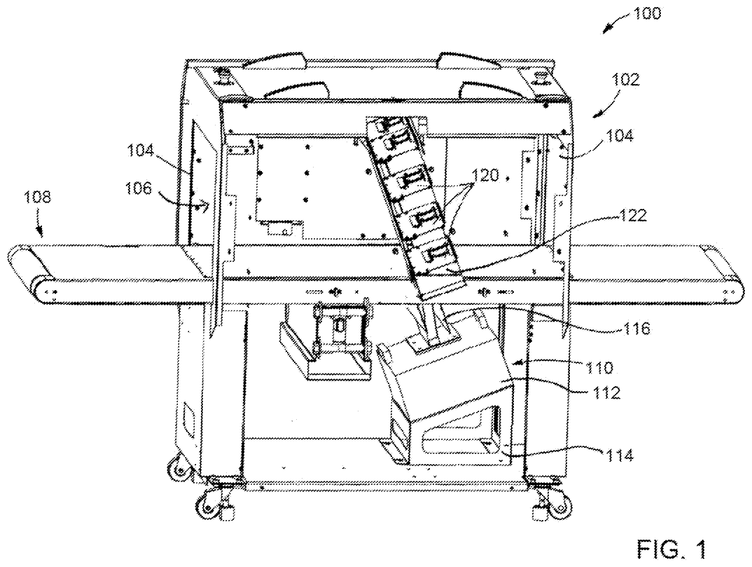

According to the aspect shown in FIG. 1, there is provided an exemplary x-ray scanning device 100. The x-ray scanning device 100 includes a housing 102 having openings 104 at either end thereof. The openings 104 provide access to a scanning chamber 106 passing through the housing 102. The system 100 may further include a displacement assembly 108, such as a conveyor, which extends through the scanning chamber 106 and which may be used to displace at least one object of interest to be scanned using the x-ray scanning device 100. The x-ray scanning device 100 further includes a source assembly 110. The source assembly 110 includes a source (not shown) for emitting electromagnetic radiation such as x-rays, a source assembly housing 112 at least partially enclosing the source, a pedestal 114 to which the source assembly housing 112 is mounted and a collimator 116 mounted to the source assembly housing 112 for directing x-rays emitted from the source. Collimator 116 may for example be a fan-shaped collimator for directing the x-rays in a fan-shaped beam. However, collimator 116 may be of any suitable shape and not only fan-shaped.

The x-ray scanning device 100 may further include a group of detectors including at least one detector 120 and preferably a plurality of detectors 120 each mounted to the bracket 122. In one aspect, the bracket is an L-shaped bracket which is positioned within the scanning chamber 106 such that the plurality of detectors 120 are mounted at least partially about the scanning chamber 106. In the aspect shown in FIG. 1 there is shown mounted within the scanning chamber a single bracket 122. In other aspects, the scanning chamber may include more than one bracket positioned within the scanning chamber and that the brackets do not have to have same orientation or angular position. It should be further understood that the bracket 122 does not have to be L-shaped. Rather, the bracket 122 may be linear or arc shaped or any other suitable shape.

In some embodiments, each detector 120 includes a detector card having a center point and edges. The center point corresponds to the geometric center of the detector cards. The edges of each detector card define the boundaries of the detector 120.

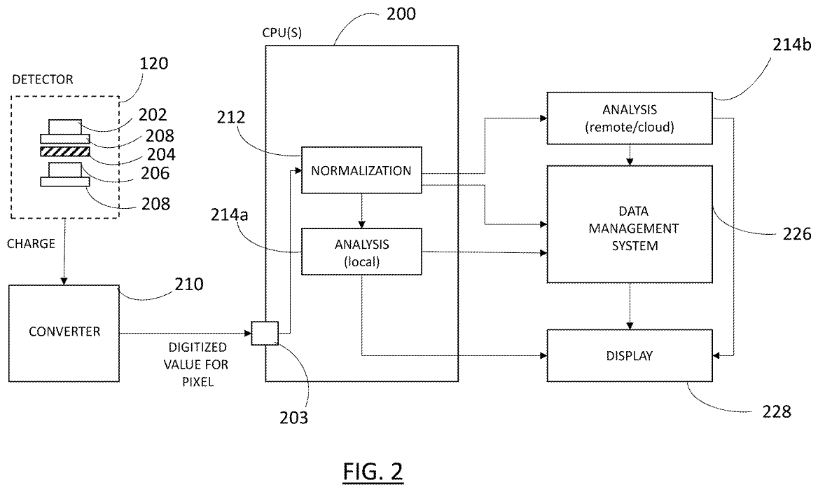

As shown in FIG. 2, each detector 120 may comprise a first scintillator 202, a filter 204 and a second scintillator 206. All of these may be sandwiched together as shown in FIG. 2 or may be otherwise suitably arranged. In a scanning operation, broad-spectrum x-rays are emitted by the source and are directed by the collimator 116 toward the plurality of detectors 120 within the scanning chamber 106. In the case of each detector 120, a plurality of the emitted x-rays encounters the first scintillator 202 which may be configured to detect the lower portion of the emitted x-ray signal spectrum. Residual low energy x-ray signals may then be stopped by the filter 204 and remaining x-ray signals from the emitted x-rays reach the second scintillator 206 which may be configured to detect a higher portion of the x-ray signal spectrum.

With further reference to FIG. 2, in one aspect, each of the scintillators 202, 206 converts the detected x-ray energy to light. Each of these scintillators 202, 206 is coupled with a photodiode 208 which captures the light from the respective scintillator 202, 206 and generates a corresponding analog electric signal, such as a photo current signal. The electric signal is further digitized by a converter 210. The digitized signal value is associated with a pixel of an image for providing a visual representation of a portion of an object within the scanning volume being scanned. The detectors thus measure to what degree the x-ray signal has attenuated due to passing through a defined inspection volume.

In the conversion of the light into an electric signal by the photodiodes 208, some uncertainties may be introduced in that a given light source may result in different electric signals since every detector card reacts slightly differently to the presence or absence of the electromagnetic radiation of an x-ray. In order to correct these variations and for the final image to appear more homogenously, each pixel of the image may be normalized by correcting an offset and gain in the light conversion. Such a normalization procedure may be executed for example using a normalization module 212 as shown in FIG. 2 in order to compensate for slight variations in offset and gain for each detector, as well as for estimating the expected uncertainties in the low-energy and high-energy signals and/or attenuation for each detector.

Detectors 120 and the x-ray scanning device 100 may be linked to one or more local central processing units (CPU) 200 or other local processing device coupled with the x-ray scanning device 100 via a suitable communication means such as input port 203. Thereby, x-ray signals detected by the detectors 120 may be analyzed locally using, for example, analysis module 214a. The information output from the analysis module 214a may be output locally. Such output may include output of an image to a display 228 for review by security personnel or to a suitable data storage volume, database or preferably data management system 226. Alternatively, the CPU may be configured to provide the x-ray scanning data to a remote location or cloud system for remote analysis 214b, via a suitable communication means, such as a network connection, for processing and may be further configured to receive from the remote location 214b the processed information sent back to the x-ray scanning device or a computer or monitor operably coupled therewith.

The detected x-ray energy signals resulting from the steps described above, once digitized, provide one or more raw x-ray image data sets which can be displayed in graphical form and can be recognized by a human technician as indicating the presence of particular structures representing a specific class of objects or materials in the object.

In another aspect, the x-ray scanning device 100 may include a cadmium zinc telluride (CZT) detector. CZT detectors are designed with a thin layer of metal deposited on the detector surfaces to act as electrodes. These electrodes allow the CZT detectors to be electrically biased to creating an electrical potential across the detector. CZT detectors can directly convert x-rays into electrons and provide high detection efficiency and the capability of multi-energy imaging.

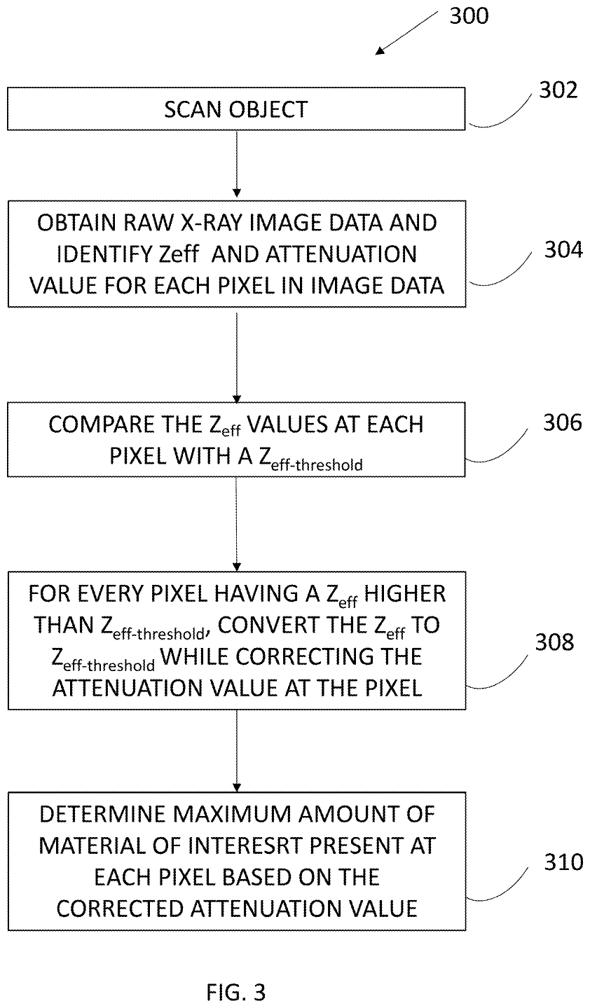

FIG. 3 is a flowchart summarizing the operational process 300 of one aspect of the invention. In a first step 302, an object is scanned using an x-ray scanning device. In one aspect, the object may be scanned using the x-ray scanning device 100 described above with reference to FIG. 1. At step 304, raw x-ray image data, is generated from scanning the object. In one aspect, the raw x-ray data images may be produced by performing an x-ray scanning operation on an object using an x-ray scanning device, for example, in the manner described above with reference to FIG. 1 and FIG. 2.

The raw x-ray image data sets are made up of a plurality of pixels. Each pixel in the plurality of pixels has associated therewith an attenuation value and an effective atomic number (Z_{eff}) value. The attenuation value of a pixel, among other factors, represents the reduction in intensity of an x-ray beam as it traverses the matter present in the object being scanned. The attenuation value can vary depending on the type and thickness of the matter through which the x-ray beam passes. The Z_{eff} value associated with a pixel represents the effective atomic number of the various materials composing the object through which the x-ray beam passes. Z_{eff} values vary for different types of materials. For instance, organic materials like food, clothing, explosives and other toxic materials have lower Z_{eff} values while inorganic materials like metals have higher Z_{eff} values. The attenuation values and Z_{eff} values associated with each pixel are identified at step 304.

At step 306, the Z_{eff} values associated with each pixel in the raw data image is compared with a threshold effective atomic number for a material of interest (Z_{eff-threshold}). The threshold effective atomic number can be predetermined prior to method 300 or determined as a precursor to step 306.

For every pixel having a Z_{eff} value lower than the Z_{eff-threshold} value, the attenuation value of the pixel is representative of the potential maximum amount of the material of interest present in that region of the object. Since the attenuation value of the pixel is already representative of the potential maximum amount of the material of interest present in that region of the object, no transformation or correction is required at that pixel.

For every image pixel having a Z_{eff} value greater than the Z_{eff-threshold} value, the attenuation value of the pixel may represent contribution from the x-ray passing through different types of materials. It would be advantageous to convert the signal at pixels having a Z_{eff} value greater than the Z_{eff-threshold} value, to show the potential contribution from the x-ray passing through only a material of interest. This would allow for an improved detection of the material of interest in an object.

At step 308, to identify the maximum potential contribution to the signal from only the material of interest, for every image pixel having a Z_{eff} value greater than the Z_{eff-threshold} value, the Z_{eff} value is converted to the Z_{eff-threshold} while simultaneously applying a correction factor to correct the attenuation value of the pixel. The attenuation value is corrected based on a difference between Z_{eff} and Z_{eff-threshold} (ΔZ_{eff}). The correction factor to be applied is a function of attenuation and Z_{eff} of the overlapping materials. The correction factor for different material overlaps may be predetermined and stored for retrieval during the operation described herein. Such storage may, for example, take the form of one or more lookup tables created through repeated scanning of reference materials. The reference materials may include various combinations of organic and inorganic materials, organic materials only or inorganic materials only. In one instance, the reference materials used include plexiglass, aluminum, and steel. Preferably, the lookup tables store attenuation values and effective atomic number values for a wide variety of organic material and inorganic material overlaps. Thereby, the x-ray signal information for a variety of organic and inorganic material overlaps may be easily retrieved during an image raw data processing or enhancement operation.

At step 310, the corrected attenuation value for each pixel is used to determine the potential maximum amount or thickness of the material of interest that is present at each pixel. In a preferred aspect, an image may then be generated representing the potential maximum amount of the material of interest that is present at each pixel. If no material of interest is present in a given region of the object, then the corresponding image pixel will be blank. If the material of interest is present in a given region of the object, the potential maximum amount, or thickness, of the material of interest can be determined from the corrected attenuation value of the pixel. For a region of the object having a higher amount of the material of interest, the corresponding pixel may be darker or more intensely colored as compared to a pixel for a region of the object having a lower amount of the material of interest. Displaying this information as an image allows a human operator to make a visual assessment as to which areas of an image, and hence a scanned object, may have a higher likelihood of containing the material of interest.

In a preferred embodiment, the material of interest is an organic material. The Z_{eff-threshold} value for organic materials may be set using an organic material having a low Z_{eff} value as a calibration material. In a preferred aspect, for detection of the presence of organic materials, plexiglass may be used as the calibration material to determine the Z_{eff-threshold} value. The look-up tables may be created using plexiglass as a calibration material in combination with an inorganic material such as steel as the reference material. To identify the maximum potential contribution to the signal from only organic materials, for every image pixel having a Z_{eff} value greater than the Z_{eff-threshold} value, the Z_{eff} value is converted to the Z_{eff-threshold} while simultaneously applying a correction factor to correct the attenuation value of the pixel. When the correction factor is applied to the attenuation value for each pixel, the signal contribution from the inorganic material is removed and the corrected attenuation value represents the signal contribution from the organic material alone. In a physical sense, the signal contribution of the organic material at each pixel represents the maximum potential amount of organic material that may be present at that location in the scanned object. It should be noted that the corrected attenuation value determines the maximum amount of organic material that may be present at each pixel and not the actual amount of organic material present, which may be lower.

In another embodiment, the material of interest may be an inorganic material such as aluminum. The Z_{eff-threshold} value for detecting the presence of aluminum can be set using aluminum as a calibration material. The look-up tables may be created using aluminum as a calibration material in combination with an inorganic material such as steel as the reference material. To identify the maximum potential contribution to the signal from aluminum, for every image pixel having a Z_{eff} value greater than the Z_{eff-threshold} value, the Z_{eff} value is converted to the Z_{eff-threshold} while simultaneously applying a correction factor to correct the attenuation value of the pixel. When the correction factor is applied to the attenuation value for each pixel, the corrected attenuation value represents the signal contribution from aluminum alone. In a physical sense, the signal contribution from aluminum at each pixel represents the maximum potential amount of aluminum that may be present at that location in the scanned object. It should be noted that the corrected attenuation value determines the maximum amount of aluminum that may be present at each pixel and not the actual amount of aluminum present, which may be lower.

In a preferred aspect, an image may then be generated representing the potential maximum amount of the material of interest that is present at each pixel. If no material of interest is present in a given region of the object, then the corresponding image pixel will be blank. If the material of interest is present in a given region of the object, the potential maximum amount, or thickness, of the material of interest can be determined from the corrected attenuation value of the pixel. For a region of the object having a higher amount of the material of interest, the corresponding pixel may be darker or more intensely colored as compared to a pixel for a region of the object having a lower amount of the material of interest. Displaying this information as an image allows a human operator to make a visual assessment as to which areas of an image, and hence a scanned object, may have a higher likelihood of containing the material of interest. In a still preferred aspect, the material of interest is an organic material and displaying an image showing the maximum potential amount of organic material that may be present at each pixel visually illustrates the areas in an object where an organic material may be present. Thereby, the operator can focus on specific areas of an image pixel or region which are more likely to potentially conceal a threat, for example, an explosive material.

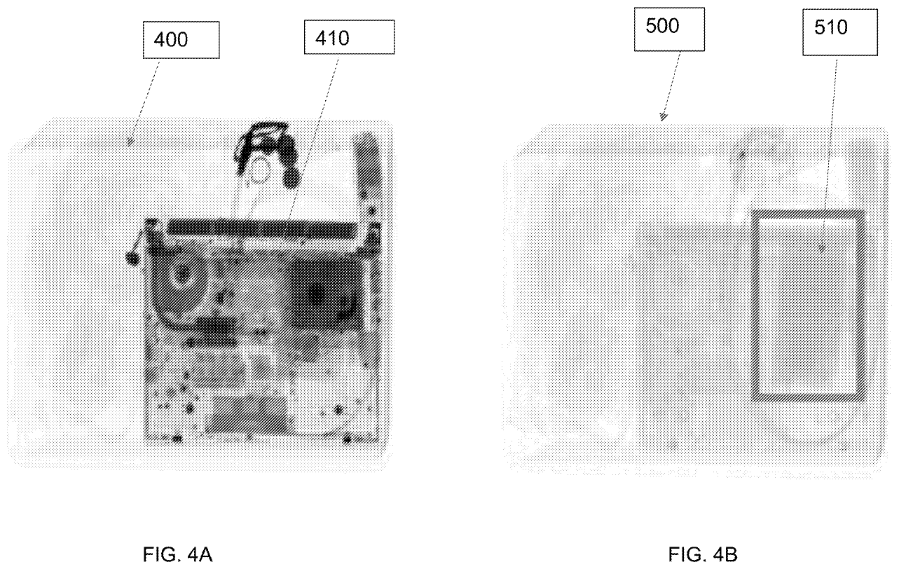

FIG. 4A depicts a top view of an x-ray image gencrated as described above with reference to FIGS. 1 and 2. An object is passed though the x-ray scanning device 100 of FIG. 1 to generate an image 400 of the object. FIG. 4A illustrates a cluttered region 410 of the image that makes detection of potential threats difficult as the organic material cannot be clearly distinguished from the other materials that superimpose or underlay the organic material.

FIG. 4B depicts a top view of a modified x-ray image 500 of an object of interest obtained from the process 300 as described above with regard to FIG. 3. FIG. 4B illustrates that maximum amount of the organic material that may be present in each region of the image 500 of the object of interest. If a pixel is blank, then no organic material is present. If organic material is present, the potential maximum amount (thickness) can be determined from the corrected attenuation value. In one example, region 510 in FIG. 4B depicts a region with a greater amount of organic material that may be present as compared to the rest of the image. Presenting this additional image information to operators of x-ray scanning devices can greatly help them in identifying potential threat regions in an object. In another aspect, this image information can also be directly used by an automated threat detection algorithm with an image processing functionality that can highlight these regions for operator review.

While the invention has been described in terms of specific embodiments, it is apparent that other forms could be adopted by one skilled in the art. For example, the methods described herein could be performed in a manner which differs from the embodiments described herein. The steps of each method could be performed using similar steps or steps producing the same result, but which are not necessarily equivalent to the steps described herein. Some steps may also be performed in different order to obtain the same result. Similarly, the apparatuses and systems described herein could differ in appearance and construction from the embodiments described herein, the functions of each component of the apparatus could be performed by components of different construction but capable of a similar though not necessarily equivalent function, and appropriate materials could be substituted for those noted. Accordingly, it should be understood that the invention is not limited to the specific embodiments described herein. It should also be understood that the phraseology and terminology employed above are for the purpose of disclosing the illustrated embodiments, and do not necessarily serve as limitations to the scope of the invention.

What is claimed is:

1. A method for detecting a presence of a material in an object, the method comprising:
obtaining raw x-ray image data for the object from an X-ray scanning device, the raw x-ray image data comprising a plurality of pixels, wherein each pixel of the plurality of pixels has associated therewith an attenuation value and an effective atomic number (Z_{eff}) value;
converting, for each pixel having a Zefrvalue greater than a threshold effective atomic number (Z_{eff-threshold}), the Z_{eff} value at the pixel to the Z_{eff-threshold} while applying a correction factor to the attenuation value for the pixel to bring the attenuation value into correspondence with the conversion of the Z_{eff} value for the pixel; and,
determining a maximum potential amount of the material present at each pixel based on the corrected attenuation value at the pixel.

2. The method of claim 1, further comprising the step of:
determining the Z_{eff-threshold} based on an effective atomic number of a calibration material.

3. The method of claim 2, wherein the material to be detected is an organic material, and wherein the calibration material is plexiglass.

4. The method of claim 2, wherein the material to be detected is aluminum, and wherein the calibration material is aluminum.

5. The method of claim 1, further comprising the step of:
generating an image showing the maximum potential amount of the material that is present at each pixel of the image.

6. The method of claim 5, further comprising the step of:
providing the image to a display.

7. The method of claim 1, wherein the correction factor is based on a difference between the Z_{eff} at the pixel and the Z_{eff-threshold}.

8. The method of claim 1, wherein the correction factor is obtained from a look-up table storing attenuation values and Z_{eff} values for various material overlaps.

9. The method of claim 1, wherein the material to be detected is an inorganic material.

10. A system for detecting a presence of material in an object, the system comprising:
an x-ray scanning device for obtaining raw x-ray image data for the object, the raw x-ray image data comprising a plurality of pixels, wherein each pixel of the plurality of pixels has associated therewith an attenuation value and an effective atomic number (Z_{eff}) value; and
at least one processor configured to:
convert, for each pixel having a Z_{eff} value greater than a threshold effective atomic number (Z_{eff-threshold}), the Z_{eff} value at the pixel to the Z_{eff-threshold} while applying a correction factor to the attenuation value for the pixel to bring the attenuation value into correspondence with the conversion of the Z_{eff} value for the pixel; and
determine a maximum potential amount of material present at each pixel based on the corrected attenuation value at the pixel.

11. The system of claim 10, wherein the at least one processor is configured to determine the Z_{eff-threshold} based on an effective atomic number of a calibration material.

12. The system of claim 11, wherein the material to be detected is an organic material, and wherein the calibration material is plexiglass.

13. The system of claim 11, wherein the material to be detected is aluminum, and wherein the calibration material is aluminum.

14. The system of claim 10, wherein the at least one processor is further configured to generate an image showing the maximum potential amount of the material that is present at each pixel of the image.

15. The system of claim 13, wherein the at least one processor is further configured to provide the image to a display.

16. The system of claim 10, wherein the correction factor is determined based on a difference between the Z_{eff} value at the pixel and the Z_{eff-threshold}.

17. The system of claim 10, wherein the correction factor is obtained from a look-up table storing attenuation values and Z_{eff} values for various material overlaps.

18. The system of claim 17, wherein the material to be detected is an inorganic material.

19. A method for enhancing a display of raw x-ray image data of an object to identify if a region of the object contains organic material, the method comprising:
obtaining the raw x-ray image data of the object, wherein the raw image data comprises a plurality of pixels, and wherein each pixel of the plurality of pixels has associated therewith an attenuation value and an effective atomic number (Z_{eff}) value;
converting, for each pixel having a Z_{eff} value greater than a threshold effective atomic number for organic material (Z_{eff-threshold}), the Z_{eff} value at the pixel to the Z_{eff-threshold} while applying a correction factor to the attenuation value for the pixel to bring the attenuation value into correspondence with the conversion of the Zor value for the pixel; and
displaying an image of the object showing a maximum potential amount of the organic material present at each pixel based on the corrected attenuation value of the pixel.
